(19) United States
(12) Patent Application Publication
(10) Pub. No.: US 2016/0054836 A1
(43) Pub. Date: Feb. 25, 2016

(54) TOUCH PANEL

(71) Applicant: TPK Touch Solutions (Xiamen) Inc., Xiamen (CN)

(72) Inventors: Defa Wu, Jinjiang (CN); Yanjun Xie, Wuhan (CN); Yau-Chen Jiang, Hsinchu (TW); Jianbin Yan, Putian (CN); Yanping Lai, Xiamen (CN); Kwan-Sin Ho, Miaoli (TW); Renyuan Yan, Fuzhou (CN); Wenguang Wang, Shaowu (CN); Junping Yang, Longhai (CN); Tsai-Kuei Wei, Hsinchu (TW); Xiaoxin Bai, Xiamen (CN); Caijin Ye, Xiamen (CN)

(21) Appl. No.: 14/831,877

(22) Filed: Aug. 21, 2015

(30) Foreign Application Priority Data
Aug. 21, 2014 (CN) 201410414898.7

(51) Int. Cl. G06F 3/047; G09G 5/00

(52) U.S. Cl. CPC G06F 3/047; G09G 5/003; G09G 2300/0426

(57) ABSTRACT

A touch panel comprises a substrate, a wire structure, a sensing electrode structure comprised first sensing arrays and second sensor arrays defining a touch region, and a first connecting component located in a non-touch region. The wire structure is disposed in the non-touch region and electrically coupled with the sensing electrode structure and the first connecting component. The wire structure comprises first signal wires, second signal wires and an insulation component, wherein each of the first signal wires is either on one side of the second sensing arrays and disposed between the substrate and the insulation component, or is disposed correspondingly on the insulation component. By separating the wire structure into an upper layer and a lower layer, the width of the wire structure and hence that of the frame are reduced in the touch panel.

### BACKGROUND OF THE INVENTION

This non-provisional application claims priority under 35 U.S.C. §119(a) on Patent Application No(s). 201410414898.7 filed in China on Aug. 21, 2014, the entire contents of which are hereby incorporated by reference.

### TECHNICAL FIELD

The present disclosure relates to touch panels, and particularly to touch panels with stacked wires in upper and lower layers to achieve a slim border design.

### DESCRIPTION OF THE RELATED ART

According to purchase trends of electronic products, consumers are beginning to prefer products with larger touch panels and thinner profiles. However, larger touch panels require more sensing electrodes, and more signal wires required for signal transmission are connected to the sensing electrodes. Therefore, in order to achieve thin profile case design, a slim border for reducing the size of the non-touch region is important.

In some configurations, a slim border is implemented by reducing the width and number of the signal wires around the sensing electrode or reducing the spacing between the signal wires. However, reducing the width of the signal wire or reducing the spacing between the signal wires leads to the problem of open circuits or short circuits, and reducing the number of signal wires may also reduce the quality of the touch panel.

### SUMMARY OF THE INVENTION

A touch panel includes a substrate, a sensing electrode structure, a first connecting component, and a wire structure. A touch region and a non-touch region corresponding to the touch panel are both defined on the substrate. The sensing electrode structure is on the substrate and defines the touch region, and the sensing electrode structure includes a plurality of first sensing arrays and a plurality of second sensing arrays, wherein the plurality of first sensing array and the plurality of second sensing arrays are insulated to each other and are arranged interlacedly. The first connecting component is on an end of the plurality of second sensing arrays on the substrate and inside the non-touch region. The wire structure is on the substrate and inside the non-touch region and includes a plurality of first signal wires, a plurality of second signal wires, and an insulation component. The plurality of first signal wires is electrically connected to the plurality of first sensing arrays and the first connecting component respectively. The plurality of second signal wires is between the sensing electrode structure and the first connecting component, and is electrically connected to the plurality of second sensing arrays and the first connecting component respectively. Part of the plurality of first signal wires on the same side of the plurality second sensing arrays are between the substrate and the insulation component, and the other part of the plurality of first signal wires are on the insulation component.

### BRIEF DESCRIPTION OF THE DRAWINGS

The present disclosure will become more fully understood from the detailed description given hereinbelow and the accompanying drawings, which are given by way of illustration only and thus are not limitative of the present disclosure and wherein:

FIG. 1 is a top view of a touch panel according to one or more embodiments;

FIG. 2A is a cross-sectional diagram of a touch panel according to the cross-sectional line 2A-2A in FIG. 1 in some embodiments;

FIG. 2B is a cross-sectional diagram of a touch panel according to the cross-sectional line 2B-2B in FIG. 1 in some embodiments;

FIG. 2C is a cross-sectional diagram of a touch panel according to the cross-sectional line 2C-2C in FIG. 1 in some embodiments;

FIG. 2D is a cross-sectional diagram of a touch panel according to the cross-sectional line 2A-2A in FIG. 1 in some other embodiments;

FIG. 3A is a top view of a touch panel according to some embodiments;

FIG. 3B is a cross-sectional diagram of a touch panel according to the cross-sectional line 3B-3B in FIG. 3A in some embodiments;

FIG. 4A is a top view of a touch panel according to some embodiments;

FIG. 4B is a cross-sectional diagram of a touch panel according to the cross-sectional line 4B-4B in FIG. 4A in some embodiments;

FIG. 5 is a top view of a touch panel according to some embodiments;

FIG. 6A is a top view of a touch panel according to some embodiments;

FIG. 6B is a cross-sectional diagram of a touch panel according to the cross-sectional line 6B-6B in FIG. 6A in some embodiments;

FIG. 7 is a top view of a touch panel according to some embodiments;

FIG. 8A is a top view of a touch panel according to some embodiments;

FIG. 8B is a cross-sectional diagram of a touch panel according to the cross-sectional line 8B-8B in FIG. 8A in some embodiments;

FIG. 9 is a top view of a touch panel according to some embodiments;

FIG. 10 is a top view of a touch panel according to some embodiments;

FIG. 11 is a top view of a touch panel according to some embodiments;

FIG. 12A is a diagram of a first signal wire layout according to FIG. 1;

FIG. 12B is another diagram of a first signal wire layout according to FIG. 1;

FIG. 12C is a further diagram of a first signal wire layout according to FIG. 1; and

FIG. 12D is yet another diagram of a first signal wire layout according to FIG. 1.

### DETAILED DESCRIPTION OF THE INVENTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawings.

The figures in the present disclosure are simplified diagrams for illustrating the basic structures of the present disclosure. Therefore, only the related components are labeled in the figures and the components are not illustrated with real numbers, shapes, sizes, and ratios. The practical sizes for implementation are selective according to the design, and the layout of the components can be more complicated. In addition, the up, down, left, and right relationships of the illustrated components are only for illustrating but not for limiting the present disclosure.

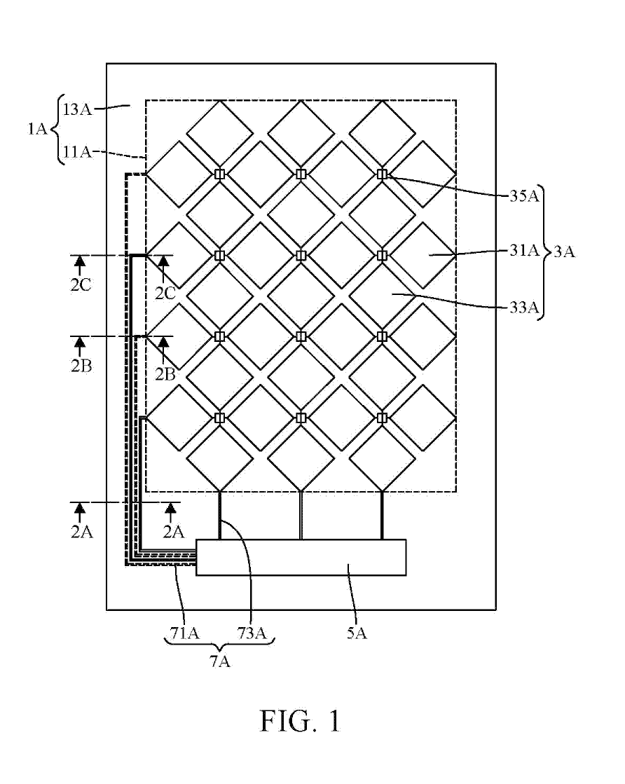

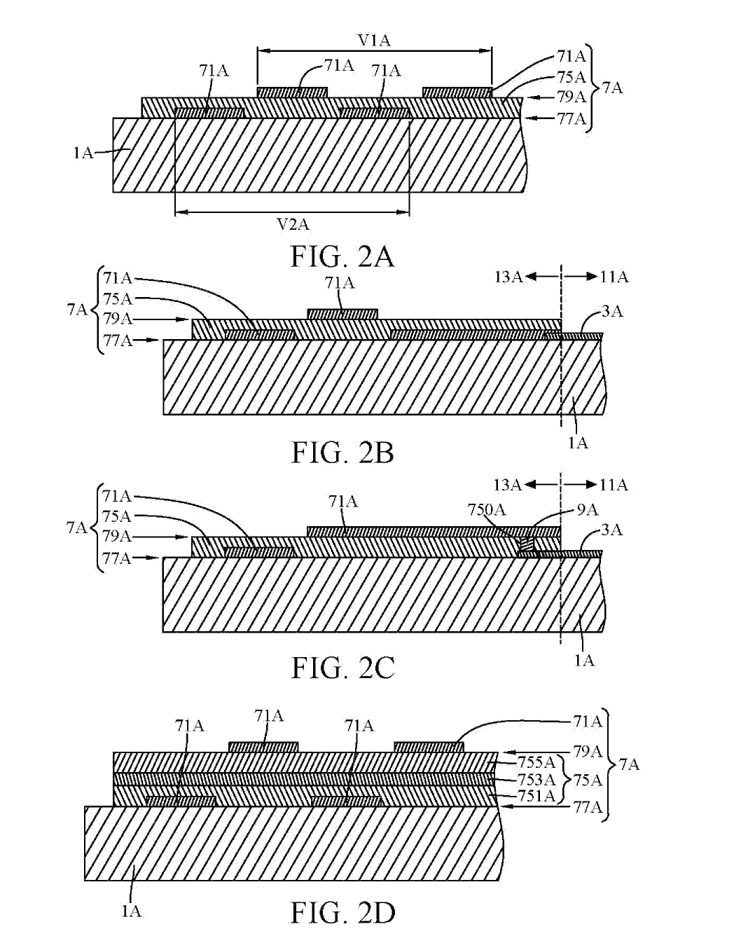

Please refer to FIG. 1 and FIG. 2A. FIG. 1 is a top view of a touch panel according to at least one embodiment. FIG. 2A is a cross-sectional diagram of a touch panel along the cross-sectional line 2A-2A in FIG. 1 in some embodiments. As shown in the figures, the touch panel includes a substrate 1A, a sensing electrode structure 3A, a first connecting component 5A, and a wire structure 7A. The sensing electrode structure 3A, the first connecting component 5A, and the wire structure 7A are on the substrate 1A. In practice, the touch panel is applicable to the monitor of a smart phone, an Automated Teller Machine (ATM), a touch computer, a touch television, a Global Positioning System (GPS) human-machine interface, or the like.

The substrate 1A is a transparent cover with a certain level of strength. Please further refer to FIG. 2A. The sensing electrode structure 3A, the first connecting component 5A, and the wire structure 7A are disposed on the surface of the substrate 1A, and the lower surface is for touch operations by users. The material is, but not limited to, tempered glass, sapphire crystal, Polyimide (PI), Polypropylene (PP), Polystyrene-5 (PS), Acrylonitrile Butadiene Styrene (ABS), Polyethylene terephthalate (PET), PolyVinyl Chloride (PVC), Polycarbonate (PC), polyethylene (PE), Polymethylmethacrylate (PMMA), Polytetrafluoroethylene (PTFE), or other transparent material which is hard or flexible. The substrate 1A is also a transparent thin film for carrying the sensing electrode structure and other components, and the material of the substrate 1A is, but not limited to, PI, PP, PS, ABS, PET, PVC, PC, PE, PMMA, PTFE, cyclic olefin copolymer (COC), or combinations of the aforementioned materials.

A touch region 11A and a non-touch region 13A in addition to the touch region 11A are defined on the substrate 1A. The area with the sensing electrode structure 3A on the substrate 1A is approximately defined as the touch region 11A, and the area without the sensing electrode structure 3A is defined as the non-touch region 13A. In the embodiments of the present disclosure, the non-touch region 13A is, for example, the left and right side of the sensing electrode structure 3A, the left, right, and lower side of the sensing electrode structure 3A, the surroundings of the sensing electrode structure 3A, or a combination of the previous areas. In some embodiments, the non-touch region 13A is located in the four surrounding sides of the touch region 11A and the specific explanation is described hereinafter.

The sensing electrode structure 3A is inside the touch region 11A and includes a plurality of first sensing arrays 31A, a plurality of second sensing arrays 33A, and an insulation block 35A. The plurality of first sensing arrays 31A are insulated from the plurality of second sensing arrays 33A, and the plurality of first sensing arrays 31A and the plurality of second sensing arrays 33A are in an interlaced arrangement. In some embodiments, the insulation between the plurality of first sensing arrays 31A and the plurality of second sensing arrays 33A is arranged such that the plurality of first sensing arrays 31A are arranged separately between each other and the plurality of second sensing arrays 33A are arranged separately between each other, and the insulation block 35A is disposed in the overlapping area between the plurality of first sensing arrays 31A and the plurality of second sensing arrays 33A. The insulation method in the plurality of second sensing arrays 33A and the plurality of second sensing arrays 31A is for illustration, but not for limiting the present disclosure. For clearer explanation, the sensing arrays arranged horizontally stand for the plurality of first sensing arrays 31A and the sensing arrays arranged vertically stand for the plurality of second sensing arrays 31A in the following embodiments. In the figures, the sensing array is formed by serializing a plurality of sensing blocks in diamond shapes. However, other shapes such as round, rectangle, pentagon, oval, or other suitable shapes are also applicable to the present disclosure. The present disclosure is not limited to the embodiments described above.

The first connecting component 5A is inside the non-touch region 13A. In some embodiments, the first connecting component 5A is in an end of the second sensing array 33A, that is, the lower side of the sensing electrode structure 3A. The present disclosure is not limited thereto. An end of the first connecting component 5A passes through the wire structure 7A and is electrically connected to the sensing electrode structure 3A, and the other end of the first connecting component 5A is connected to an external micro processor for sending the received touch signal by the sensing electrode structure 3A to the micro processor, and the micro processor analyzes the signal and executes further processes.

The wire structure 7A is disposed on the substrate 1A and inside the non-touch region 13A, and is electrically connected to the sensing electrode structure 3A and the first connecting component 5A. The wire structure 7A includes a plurality of first signal wires 71A, a plurality of second signal wires 73A, and an insulation component 75A. The plurality of second signal wires 73A are disposed between the sensing electrode structure 3A and the first connecting component 5A, and are electrically connected to the first connecting component 5A and the second sensing array 33A.

The first signal wire 71A is electrically connected to the first connecting component 5A and the first sensing array 31A. Each of the plurality of first sensing arrays 31A is electrically connected to the first connecting component 5A through a corresponding first signal wire 71A. In other words, each of the plurality of first sensing arrays 31A is connected to only one of the first signal wires 71A. In some embodiments, the first signal wires 71A are connected to the same ends of the plurality of first sensing arrays 31A, which are all located on the same side of the plurality of second sensing arrays 33A, that is, the left side of the plurality of second sensing arrays 33A in FIG. 1.

Please refer to FIG. 2A. Part of the first signal wires 71A are disposed on the substrate 1A between the substrate 1A and the insulation component 75A. The location between the substrate 1A and the insulation component 75A is called the lower layer location 77A. The other part of the first signal wires 71A are disposed on the insulation component 75A. The location on the insulation component 75A is called the upper layer location 79A. The area V1A of the first signal wire 71A in the lower layer location 77A at least partially overlaps the orthographic projection of the area V2A of the first signal wire 71A in the upper layer location 79A projected on the substrate 1A.

In some embodiments, the width W1 of the area of the first signal wire 71A is reduced by: 1) disposing the first signal wire 71A on the lower layer location 77A and the upper layer location 79A separately, and disposing the insulation component 75A to implement the insulation; and 2) partially overlapping the area of the first signal wire 71A in the lower layer location 77A with the area V2 of the first signal wire 71A in the upper layer location 79A in the direction perpendicular to the substrate 1A, so that the slim border design of the touch panel is implemented.

Please refer to FIG. 1, FIG. 2B, and FIG. 2C together. FIG. 2B is a cross-sectional diagram of a touch panel according to the cross-sectional line 2B-2B in FIG. 1 in some embodiments. FIG. 2C is a cross-sectional diagram of a touch panel according to the cross-sectional line 2C-2C in FIG. 1 in some embodiments.

The electrical connection between the first signal wire 71A in the lower layer location 77A and the first sensing array 31A is illustrated in FIG. 2B. The first signal wire 71A in the lower layer location 77A is directly connected to the first sensing array 31A to implement the electrical connection. In some embodiments, an end of the first signal wire 71A in the lower layer location 77A overlaps the first sensing array 31A. According to an order of steps of a practical manufacturing process, in some embodiments, the end of the first signal wire 71A in the lower layer location 77A is between the first sensing array 31A and the substrate 1A, or a connecting part is added to implement the electric connection. The present disclosure is not limited to the above embodiments.

The electrical connection between the first signal wire 71A in the upper layer location 79A and the first sensing array 31A is illustrated in FIG. 1 and FIG. 2C. The first signal wire 71A in the upper layer location 79A cannot be directly electrically connected to the first sensing array 31A because of the insulation component 75A. In some embodiments, the electrical connection between the first signal wire 71A in the upper layer location 79A and the first sensing array 31A is implemented by disposing the hole 750A in the corresponding location on the insulation component 75A and filling the hole 750A with the conductive material 9A, wherein the corresponding location on the insulation component 75A refers to the overlapping area of the first signal wire 71A in the upper layer location 79A and the orthographic projection of the first sensing array 31A on the insulation component 75A for electric connection. In other embodiments, the electric connection is implemented by another method, for example, by adding another conductive component to connect two components or making an opening at the corresponding location of the insulation component 75A, so that the two components are directly connected by being disposed on the edge of the insulation component 75A.

In some embodiments, the first signal wires 71A and the second signal wires 73A can be single-layer structures, such as the single-layer structures formed by copper, aluminum, silver, Indium Tin Oxide (ITO), or other conductive material. The first signal wires 71A and the second signal wires 73A can also be double-layer or multi-layer structures, such as overlapping molybdenum, aluminum, silver, ITO, and other conductive material, or the double-layer or multi-layer structures formed by molybdenum-aluminum-molybdenum or copper-ITO.

In some embodiments, the insulation component 75A is a single-layer structure and is formed by insulation materials, such as SiO2 or photoresist materials. The insulation component 75A is mainly for insulating the first signal wires 71A on the upper and lower layers. In other embodiments, the insulation component 75A is a multi-layer structure.

Please refer to FIG. 2D. FIG. 2D is a cross-sectional diagram of a touch panel according to the cross-sectional line 2A-2A in FIG. 1 in some other embodiments. As shown in FIG. 2D, the insulation component 75A includes a first insulation layer 751A, a shield layer 753A, and a second insulation layer 755A. In FIG. 2D, the structure of the insulation component 75A from the bottom to the top includes a substrate 1A, a plurality of first signal wires 71A in the lower layer 77A, a first insulation layer 751A, a shield layer 753A, a second insulation layer 755A, and a plurality of first signal wires 71A in the upper layer 79A. The shield layer 753 is formed by conductive materials and is disposed between the upper layer and lower layer of the first signal wires 71A, and is for screening electromagnetic noise between the first signal wires 71A to reduce interference between the upper layer and lower layer of the first signal wires 71A, so that the transmission of the touch signal is more stable.

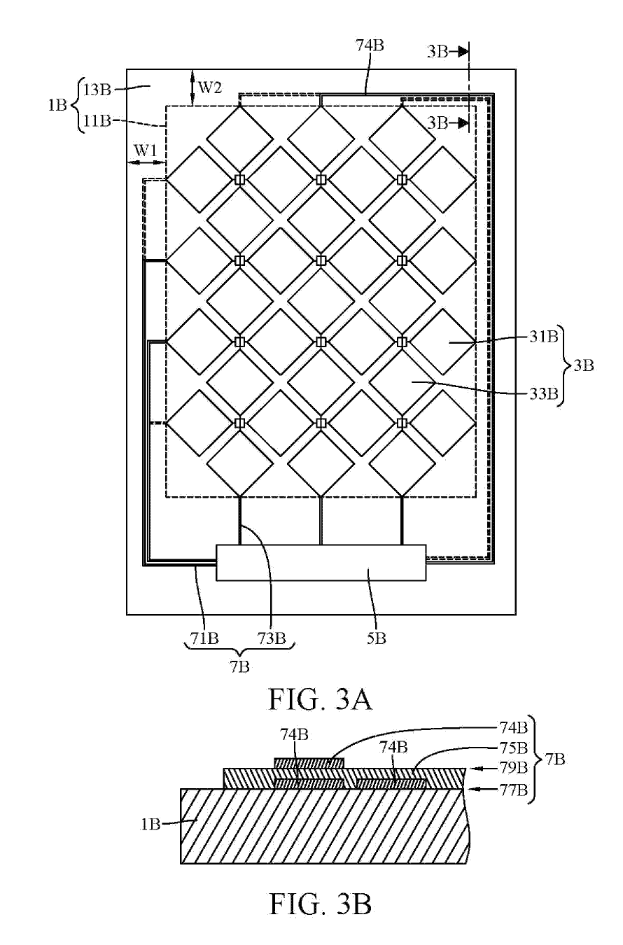

Please refer to FIG. 3A and FIG. 3B. FIG. 3A is a top view of a touch panel according to some embodiments. FIG. 3B is a cross-sectional diagram of a touch panel according to the cross-sectional line 3B-3B in FIG. 3A in some embodiments. As shown in the figures, the difference between the touch panel in of FIG. 3A and FIG. 3B and the touch panel of FIG. 1 is the combination and the layout of the wire structure 7B. Other components of the touch panels are the same, such as the substrate 1B, the sensing electrode structure 3B, and the layout of the first connecting component 5B. In addition, the definitions of the touch region 11B and the non-touch region 13B on the substrate 1B in the touch panels are also the same, and are not further explained hereinafter.

Specifically, the wire structure 7B of the touch panel of FIG. 3A and FIG. 3B includes a plurality of first signal wires 71B, a plurality of second signal wires 73B, and a plurality of third signal wires 74B. The layout of the first signal wires 71B and the second signal wires 73B are the same as the layout in FIG. 1, and are not further explained hereinafter. The third signal wires 74B are connected to the end of the second sensing array 33B which is not connected to the second signal wires 73B, and are all connected to the first connecting component 5B through the same side of the second sensing array 33B. The third signal wires 74B are respectively disposed on the upper and lower layers of the insulation component 75B, that is, part of the third signal wires 74B are disposed between the substrate 1B and the insulation component 75B, and the other part of the third signal wires 74B are disposed on the insulation component 75B. In some embodiments, the two ends of the second sensing array 33B are separately connected to the first connecting component 5B through the second signal wires 73B and the third signal wires 74B for the layout of the first signal wires 71B and the third signal wires 74B in the wire structure 7B, so that the width W1 of the area of the first signal wire 71B and the width W2 of the area of the third signal wires 74B are reduced and the slim border design of the touch panel is implemented.

The figure of some embodiments illustrates that the third signal wires 74B are all connected to the first connecting component 5B through the right side of the second sensing array 33B, and the first signal wires 71B are all connected to the first connecting component 5B through the left side of the second sensing array 33B. Therefore, the problem of excessively concentrating the signal wires and the signal interference from disposing the signal wires on the same side of the second sensing array 33B are avoided. However, the layout of the third signal wires 74B is implemented according to the practical needs of the product in other embodiments of the present disclosure.

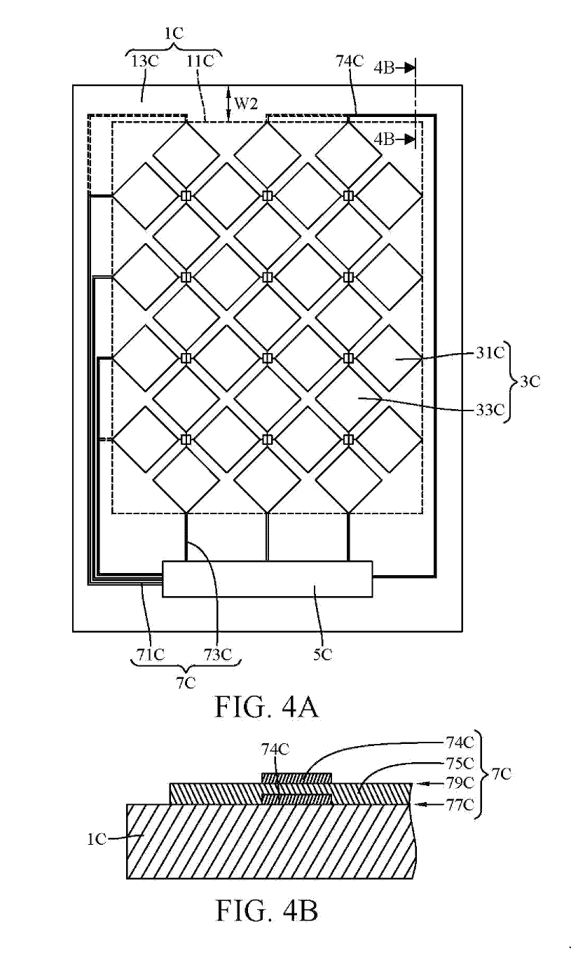

Please refer to FIG. 4A and FIG. 4B. FIG. 4A is a top view of a touch panel according to some embodiments. FIG. 4B is a cross-sectional diagram of a touch panel according to the cross-sectional line 4B-4B in FIG. 4A in some embodiments. As shown in the figures, the difference between the touch panel of FIG. 4A and the touch panel of FIG. 3A is the layout of the third signal wires 74C in the wire structure 7C. The other components of the touch panels are the same, such as the substrate 1C, the sensing electrode structure 3C, the first connecting component 5C, and the layout of first signal wire 71C and the second signal wire 73C in the wire structure 7C. In addition, the definitions of the touch region 11C and the non-touch region 13C on the substrate 1C are the same, and are not further explained hereinafter.

In some embodiments, the third signal wires 74C are connected to the end of the second sensing array 33C which is not connected to the second signal wires 73C, and are connected to the first connecting component 5C through the two ends of the second sensing array 33C. In other words, part of the third signal wires 74C are connected to the first connecting component 5C through the left side of the second sensing array 33C, and the other part of the third signal wires 74C are connected to the first connecting component 5C through the right side of the second sensing array 33C. Therefore, the width W2 of the area of the third signal wire 74C is further reduced. In some embodiments, the third signal wires 74C are separately disposed in the upper and lower side of the insulation component 75C. In addition, the first signal wires 71C and part of the third signal wires 74C are disposed in the left side of the second sensing array 33C, which increases flexibility to dispose the signal wires in the upper or lower side of the insulation component 75C. For example, most of the first signal wires 71C or all of the first signal wires 71C are disposed between the insulation component 75C and the substrate 1C, without limitation thereto. In some embodiments, signal interference between sensing arrays with different axes and negative effects to the sensitivity precision of the touch panel are avoided by disposing the first signal wires 71C in the upper and lower side of the insulation component 75C whose orthographic projections projected on the insulation component 75C are overlapped with each other and not overlapped with the orthographic projection of the third signal wires 74C on the insulation component 75C.

In some embodiments, the first signal wires 71A, 71B, 71C are all connected to the left side of the first sensing array 31A, 31B, 31C and pass through the same side of the second sensing array 33A, 33B, 33C. In other embodiments, the first signal wires are disposed in the two sides of the second sensing array. The method of disposing the first signal wire in the two sides of the second sensing array includes two designs. The first design is connecting all of the first signal wires to the same side of the first sensing array, and part of the first signal wires are extracted from the left side of the second sensing array and the other part of the first signal wires are extracted from the right side of the second sensing array by wire winding. The second design is connecting part of the first signal wires to the left side of part of the first sensing array, and connecting the other part of the first signal wires to the right side of the other part of the first sensing array, so the first signal wires are separately disposed to the two sides of the second sensing array. Different wiring arrangements can be selected according to the practical needs of various products.

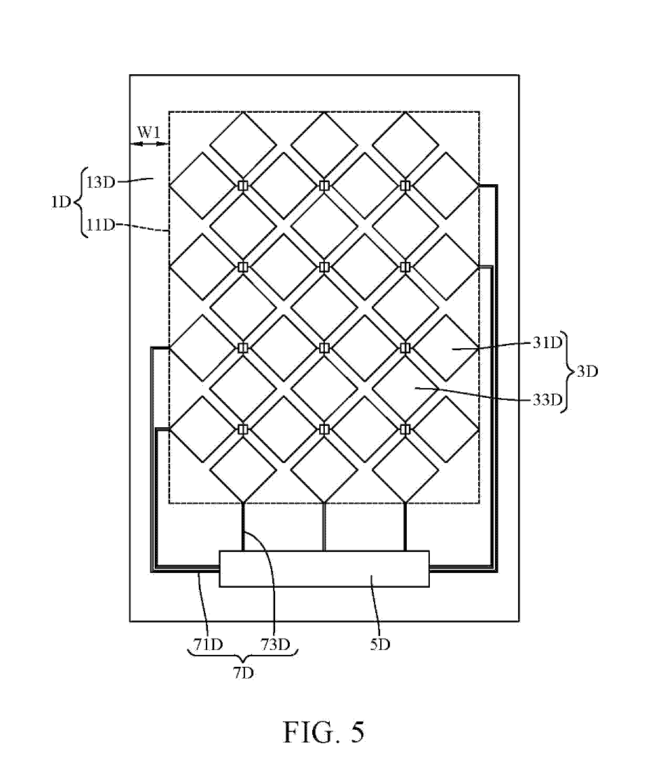

Please refer to FIG. 5. FIG. 5 is a top view of a touch panel according to some embodiments. As shown in the figures, the difference between the touch panel in FIG. 5 and the touch panel in FIG. 1 is the layout of the first signal wires 71D in the wire structure 7D. The other components of the touch panels are the same, such as the substrate 1D, the sensing electrode structure 3D, the first connecting component 5D, and the layout of the second signal wires 73D in the wire structure 7D. In addition, the definitions of the touch region 11D and the non-touch region 13D on the substrate 1D are the same as the definitions in FIG. 1, and are not further explained hereinafter.

Specifically, in some embodiments, the first signal wires 71D of the wire structure 7D are separately disposed to different sides of the second sensing array 33D. In other words, part of the first signal wires 71D are separately connected to the left side of part of the first sensing array 31D, and the other part of the first signal wires 71D are separately connected to the right side of the other part of the first sensing array 31D, and the two parts of the first signal wires 71D are connected to the first connecting component 5D through the left and right side of the second sensing array 33D. In some embodiments, the width W1 of the area of the first signal wires 71D is reduced in a maximum range by disposing the first signal wires 71D grouped on the same side of the second sensing array 33D to the two sides of the second sensing array 33D, and further disposing the first signal wires 71D on the same side of the second sensing array 33D to different layers separated by the insulation component 75D.

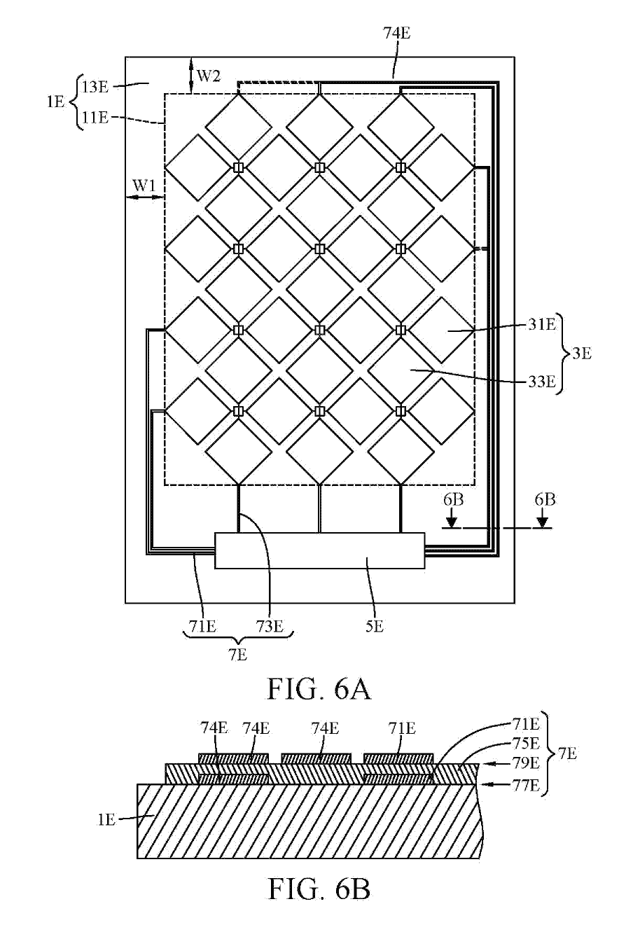

Please refer to FIG. 6A and FIG. 6B. FIG. 6A is a top view of a touch panel according to some embodiments. FIG. 6B is a cross-sectional diagram of a touch panel according to the cross-sectional line 6B-6B in FIG. 6A in some embodiments. As shown in the figures, the difference between the touch panel of FIG. 6A and the touch panel of FIG. 5 is the combination and the layout of the wire structure 7E. The other components of the touch panels are the same, such as the substrate 1E, the sensing electrode structure 3E, the layout of the first connecting component 5E. In addition, the definitions of the touch region 11E and the non-touch region 13E on the substrate 1E are the same as the definitions of FIG. 5, and are not further explained hereinafter.

The wire structure 7E of the touch panel in some embodiments includes a plurality of first signal wires 71E, a plurality of second signal wires 73E, and a plurality of third signal wires 74E. The layouts of the first signal wires 71E and the second signal wires 73E are the same as the layout shown in FIG. 5 and are not further explained hereinafter. The third signal wires 74E are connected to an end of the second sensing array 33E which is not connected to the second signal wires 73E, and are connected to the first connecting component 5E through the same side of the second sensing array 33E. The third signal wires 74E are separately disposed on the upper and lower layers of the insulation component 75E, that is, part of the third signal wires 74E are disposed between the substrate 1E and the insulation component 75E, and the other part of the third signal wires 74E are disposed on the insulation component 75E. In some embodiments, the two ends of the second sensing array 33E are separately connected to the first connecting component 5E through the second signal wires 73E and the third signal wires 74E for the layout of the first signal wires 71E and the third signal wires 74E in the wire structure 7E, so that the width W1 of the area of the first signal wires 71E and the width W2 of the area of the third signal wires 74E are reduced and the slim border design of the touch panel is implemented.

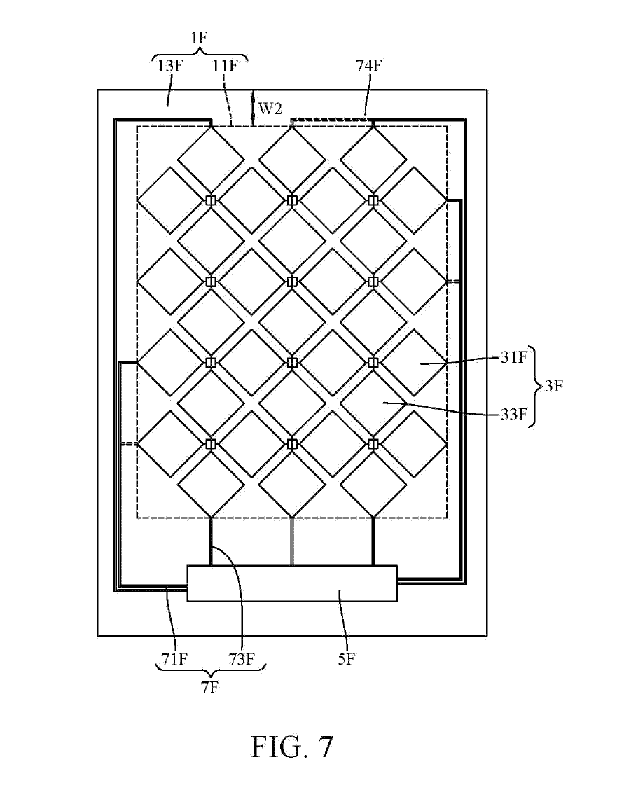

Please refer to FIG. 7. FIG. 7 is a top view of a touch panel according to some embodiments. As shown in FIG. 7, the difference between the touch panel in FIG. 7 and the touch panel in FIG. 6A is the layout of the third signal wires 74F in the wire structure 7F. The other components of the touch panels are the same, such as the substrate 1F, the sensing electrode structure 3F, the first connecting component 5F, and the layout of the first signal wires 71F and the second signal wires 73F in the wire structure 7F. In addition, the definitions of the touch region 11F and the non-touch region 13F on the substrate 1F in FIG. 7 are the same as the definitions in FIG. 6A, and are not further explained hereinafter.

Specifically, in some embodiments, the third signal wires 74F are connected to the end of the second sensing array 33F which is not connected to the second signal wires 73F, and are separately connected to the first connecting component 5F through the two sides of the second sensing array 33F. In other words, part of the third signal wires 74F are connected to the first connecting component 5F through the left side of the second sensing array 33F, and the other part of the third signal wires 74F are connected to the first connecting component 5F through the right side of the second sensing array 33F. Therefore, the width W2 of the area of the third signal wire 74F is further reduced. In some embodiments, the third signal wires 74F are separately disposed on the upper and lower sides of an insulation component. In addition, the first signal wires 71F and part of the third signal wires 74F are disposed on the left side of the second sensing array 33F, so that placing the position of the signal wires on the upper or lower side of the insulation component 75F is more flexible. For example, most of the first signal wires 71F or all of the first signal wires 71F are disposed between the insulation component 75F and the substrate 1F. In some other embodiments, the orthographic projection of the first signal wires 71F disposed on the upper and lower sides of the insulation component 75F projected on the insulation component 75F are overlapped with each other and are not overlapped with the orthographic projection of the third signal wire 74F on the insulation component 75F, so that the signal interference between the sensing array with different axes and the negative effect to the sensitivity of the touch panel are avoided.

In the previous embodiments, only one end of each of the first sensing array 31A, 31B, 31C, 31D, 31E, 31F in the touch panel is electrically connected to the first signal wire 71A, 71B, 71C, 71D, 71E, 71F, and the other end is not connected to any signal wire, namely, the single routing touch panel. In other words, the previous embodiments are improvements for the single routing touch panel, and there are also improvements for the double routing touch panel in other embodiments. “Double routing” touch panel indicates that the two ends of each first sensing array are respectively connected to a first signal wire, and in this structure, the number of the first signal wire is greater than the number of the first signal wire in the single routing structure. In addition, the double routing structure also occupies more area, so more improvements are needed to achieve the slim border of the touch panel.

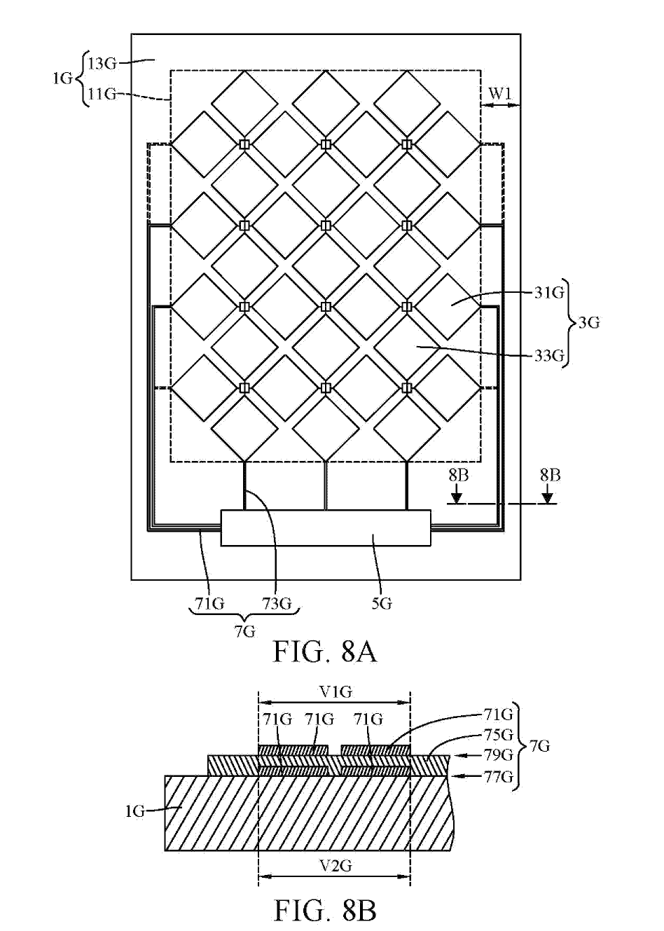

Please refer to FIG. 8A and FIG. 8B. FIG. 8A is a top view of a touch panel according to some embodiments. FIG. 8B is a cross-sectional diagram of a touch panel according to the cross-sectional line 8B-8B in FIG. 8A in some embodiments. As shown in the figures, the difference between the touch panel in FIG. 8A and the touch panel in FIG. 1 is the layout of the first signal wires 71G in the wire structure 7G, and the other components of the touch panel in FIG. 8A and the touch panel in FIG. 1 are the same, such as the substrate 1G, the sensing electrode structure 3G, the first connecting component 5G, and the layout of the second signal wires 73G in the wire structure 7G. In addition, the definitions of the touch region 11G and the non-touch region 13G on the substrate 1G in FIG. 8A are the same as the definitions in FIG. 1, and are not further explained hereinafter.

Specifically, in some embodiments, the first signal wires 71G in the wire structure 7G are respectively connected to the two ends of the first sensing array 31G, and are electrically connected to the first connecting component 5G through the two sides of the second sensing array 33G. In other words, the two ends of each of the first sensing array 31G are respectively connected to a first signal wire 71A, and the first signal wires 71G are respectively connected to the first connecting component 5G through the two sides of the second sensing array 33G. The common place between FIG. 8A and FIG. 1 is that the first signal wires 71G on the same side of the second sensing array 33G are respectively disposed between the substrate 1G and the insulation component 75A and on the insulation component 75A, wherein the location between the substrate 1G and the insulation component 75A refers the lower layer location 77G and the location on the insulation component 75A refers to the upper layer location 79G, so that the area V1G of the first signal wire 71G in the lower layer location 77G and the area V2G of the first signal wire 71G in the upper layer location 79G partially overlap in the direction perpendicular to the substrate 1G, and the width W1 of the area of the first signal wire 71G on the two sides of the second sensing array 33G is reduced correspondingly.

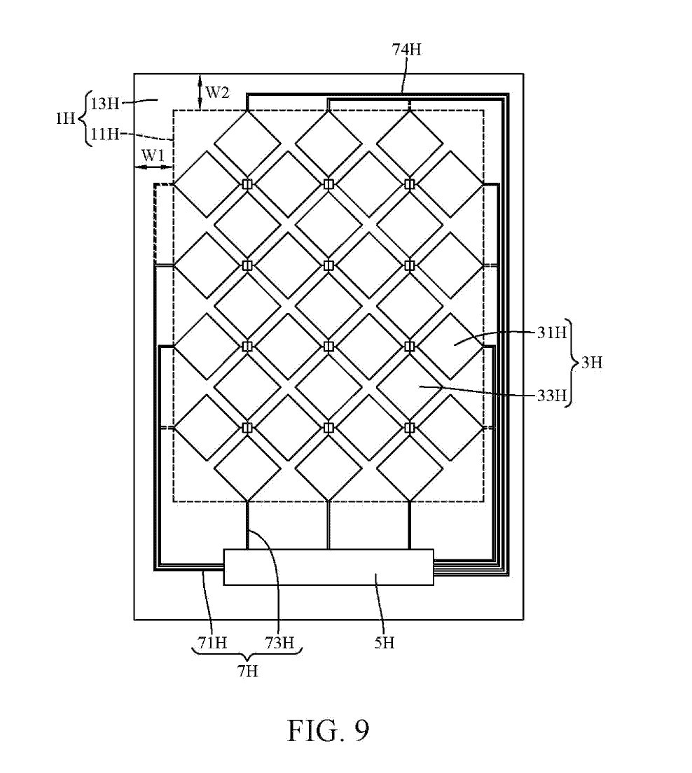

Please refer to FIG. 9. FIG. 9 is a top view of a touch panel according to some embodiments. The difference between the touch panel in FIG. 9 and the touch panel in FIG. 8A is the combination and the layout of the wire structure 7H. Other components of the touch panels are the same, such as the layout of the substrate 1H, the sensing electrode structure 3H, and the first connecting component 5H. In addition, the definitions of the touch region 11H and the non-touch region 13H on the substrate 1H in FIG. 9 are the same as the definitions in FIG. 8A, and are not further explained hereinafter.

Specifically, the wire structure 7H of the touch panel in some embodiments includes a plurality of first signal wires 71H, a plurality of second signal wires 73H, and a plurality of third signal wires 74H. The layout of the first signal wires 71H and the second signal wires 73H is the same as the layout in FIG. 8A, and is not further explained hereinafter. The third signal wires 74H are connected to the end of the second sensing array 33H which is not connected to the second signal wires 73H, and are all connected to the first connecting component 5H through the same side of the second sensing array 33H. The third signal wires 74B are respectively disposed on the upper and lower layers of the insulation component 75B, that is, part of the third signal wires 74H are disposed between the substrate 1H and the insulation component 75H, and the other part of the third signal wires 74H are disposed on the insulation component 75H. In some embodiments, the two ends of the second sensing array 33H are separately connected to the first connecting component 5H through the second signal wires 73H and the third signal wires 74H for the layout of the first signal wires 71H and the third signal wires 74H in the wire structure 7H, so that the width W1 of the area of the first signal wires 71H and the width W2 of the area of the third signal wires 74H are reduced and the slim border design of the touch panel is implemented.

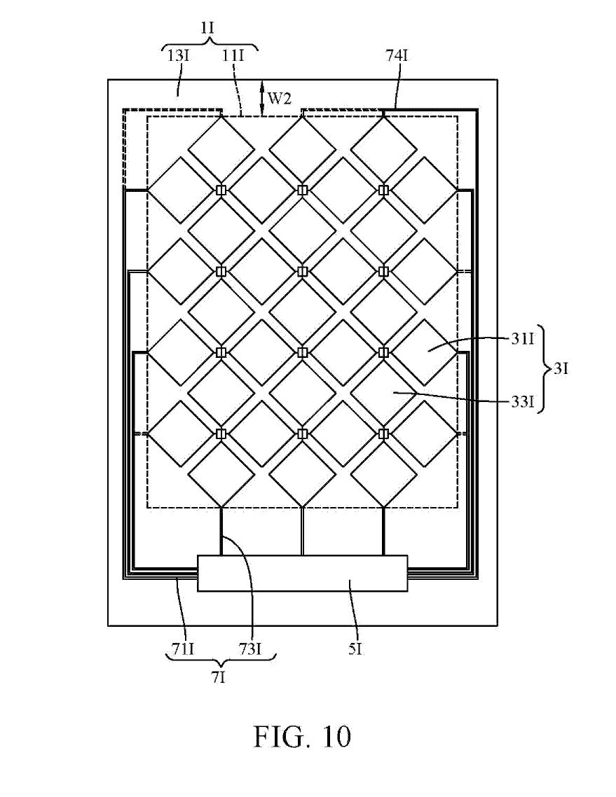

Please refer to FIG. 10. FIG. 10 is a top view of a touch panel according to some embodiments. The difference between the touch panel in FIG. 10 and the touch panel in FIG. 9 is the layout of the third signal wires 74I in the wire structure 7I. Other components of the touch panels are the same, such as the substrate 1I, the sensing electrode structure 3I, the first connecting component 5I, and the layout of the first signal wires 71I and the second signal wires 73I in the wire structure 7I. In addition, the definitions of the touch region 11I and the non-touch region 13I on the substrate 1I in FIG. 10 are the same as the definitions in FIG. 9 and the definition of the touch region 11H and the non-touch region 13H in FIG. 6A, and are not further explained hereinafter.

Specifically, in some embodiments, the third signal wires 74I are connected to the ends of the second sensing array 33I which are not connected to the second signal wires 73I, and are connected to the first connecting component 5I through the two sides of the second sensing array 33I. In other words, part of the third signal wires 74I are connected to the first connecting component 51I through the left side of the second sensing array 33I, and the other part of the third signal wires 74I are connected to the first connecting component 5I through the right side of the second sensing array 33I. Therefore, the width W2 of the area of the third signal wires 74I is reduced. In some embodiments, the third signal wires 74I are disposed on the upper and lower sides of the insulation component 75I. However, the first signal wires 71I and the third signal wires 74I are disposed on the two sides of the second sensing array 33I, so it is more flexible to dispose the plurality of signal wires on the same side, that is, in the upper or lower side of the insulation component 75I. For example, most of the first signal wires 71I or all of the first signal wires 71I are disposed between the insulation component 75I and the substrate 1I, without limitation thereto. The orthographic projection of the first signal wires 71I disposed on the upper and lower sides of the insulation component 75I projected on the insulation component 75I are overlapped with each other and are not overlapped with the orthographic projection of the third signal wires 74I on the insulation component 75I, so that the signal interference between the sensing array with different axes and the negative effect to the sensitivity of the touch panel are avoided.

In the aforementioned embodiments of the present disclosure, the first signal wires, the second signal wires, and the third signal wires are all connected to the first connecting component to implement the signal transmission between the sensing electrode structure and the first connecting component. In addition, a touch panel with a second connecting component is provided in the present disclosure and part of the signal wires connected to the first connecting component are connected to the second connecting component to reduce the wiring pressure of the first connecting component in the lateral of the substrate. In the aforementioned embodiments, the slim border design of the product can be implemented by adding a second connecting component and adjusting the connection path of the signal wire. The following explanation is based on the structure of FIG. 10.

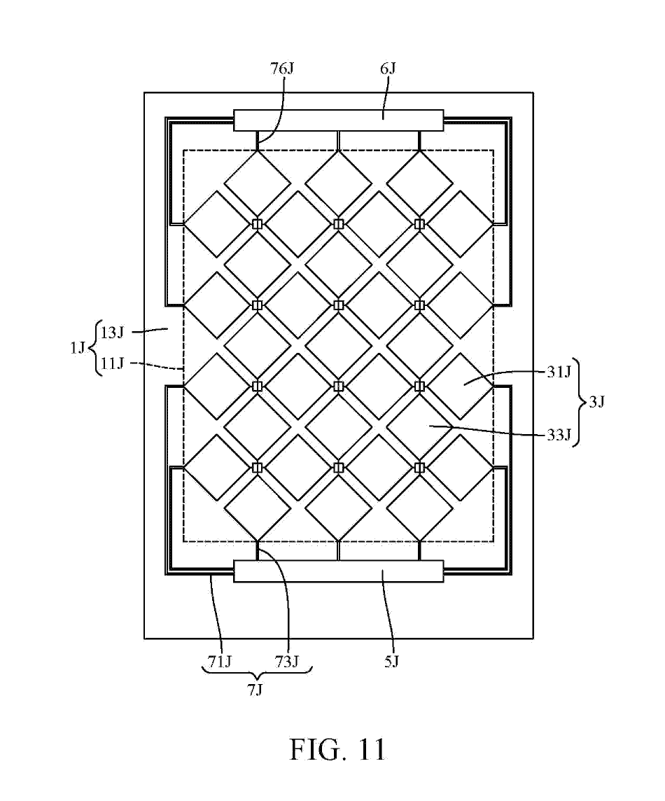

Please refer to FIG. 11. FIG. 11 is a top view of a touch panel according to some embodiments. The difference between FIG. 11 and FIG. 10 is that the touch panel further includes a second connecting component 6J. Specifically, the second connecting component 6J is on the substrate 1J and inside the non-touch region 13J in which the other end of the second sensing array 33J is located. The other end of the second sensing array 33J refers to an end at which the first connecting component 5J is not disposed. According to FIG. 11, the first connecting component 5J is inside the non-touch region of the lower end of the second sensing array 33J, and the second connecting component 6J is inside the non-touch region of the upper end of the second sensing array 33J. In some embodiments of the present disclosure, the second connecting component 6J is disposed on the right or left side of the first sensing array 31J, without limitation thereto.

As the aforementioned explanation, the second connecting component 6J is for reducing the wiring pressure of the first connecting component in the lateral regions of the substrate to satisfy the designs of different products. Correspondingly, in some embodiments, one end of part of the first signal wires 71J and one end of all of the third signal wires 74J in the wire structure 7J are connected to the corresponding first sensing array 31J and the second sensing array 33J, and the other end of part of the first signal wires 71J and all of the third signal wires 74J are connected to the second connecting component 6J. As shown in the figure, the second connecting component 6J is disposed on the upper end of the second sensing array 33J to simplify the layout of the signal wires in some embodiments, and the third signal wire 74J and part of the first signal wires 71J are connected to the second connecting component 6J based on the shortest wire method. In other embodiments, the layout of the first signal wires 71J, the second signal wires 73J, and the third signal wires 74J is planned based on the location of the second connecting component 6J according to the shortest wire method. In addition, corresponding adjustments to the layout of the signal wire are also available according to the practical needs of the product in the embodiments of the present disclosure. The embodiments are for illustrating and not for limiting the present disclosure.

Other components of the touch panel in some embodiments are the same as the components in FIG. 10, such as the substrate 1J, the sensing electrode structure 3J, the first connecting component 5J, and the layout of the wire structure 7J. The definitions of the touch region 11J and the non-touch region 13J on the substrate 1J are the same as the definitions in FIG. 10, and are not further explained hereinafter.

In the previous embodiments, the wire arrangement area of the signal wires in the non-touch region of the substrate is reduced and the implementation of slim border in the touch panel is achieved by separately disposing the first signal wires and/or third signal wires in the upper and lower layer of the insulation component and overlapping at least part of the areas of the signal wire in the upper and lower layer.

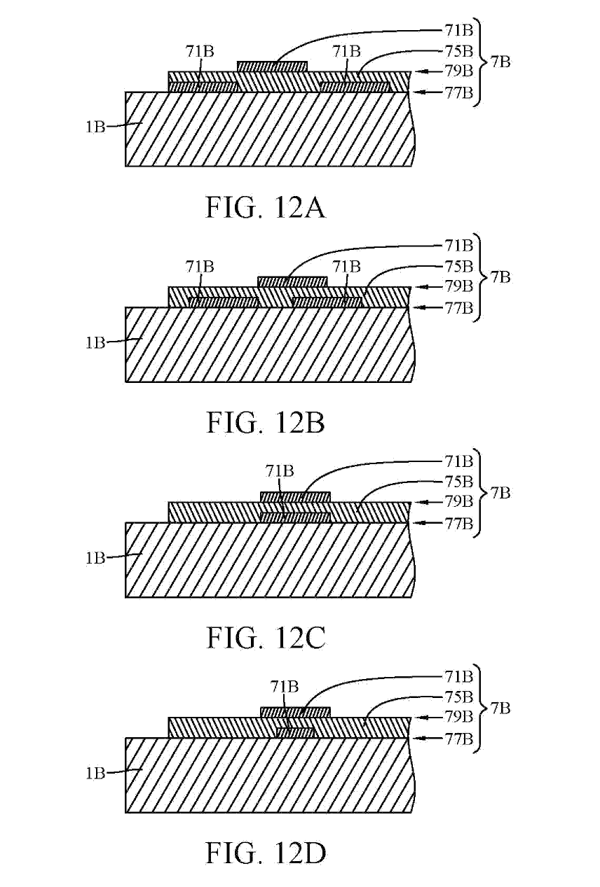

In the embodiments of the present disclosure, please refer to FIG. 12A, FIG. 12B, FIG. 12C, and FIG. 12D for the relationship between maximally saving the wire arrangement area of the signal wire in the non-touch region of the substrate and overlapping the areas of the signal wire in the upper and lower layer.

Please refer to FIG. 12A. FIG. 12A is a diagram of a first signal wire layout according to FIG. 1. As shown in FIG. 12A, the first signal wire 71B between the substrate 1B and the insulation component 75B does not overlap the orthographic projection of the first signal wire 71B on the insulation component 75B projected on the substrate 1B. In other words, the first signal wire 71B in the upper layer location 79B and the first signal wire 71B in the lower layer location 77B are overlapped side by side in the top and the bottom. According to the design, the signal interference between the first signal wire 71B in the upper layer location 79A and the first signal wire 71B in the lower layer location 77B is reduced by a certain level.

Please refer to FIG. 12B. FIG. 12B is another diagram of a first signal wire layout according to FIG. 1. As shown in FIG. 12B, the first signal wires 71B between the substrate 1B and the insulation component 75B partially overlap the orthographic projection of the first signal wire 71B on the insulation component 75B projected on the substrate 1B.

Please refer to FIG. 12C. FIG. 12C is a further diagram of a first signal wire layout according to FIG. 1. As shown in FIG. 12C, the first signal wires 71B between the substrate 1B and the insulation component 75B overlap the orthographic projection of the first signal wire 71B on the insulation component 75B projected on the substrate 1B.

Please refer to FIG. 12D. FIG. 12D is yet another diagram of a first signal wire layout according to FIG. 1. As shown in FIG. 12D, the width of the first signal wires 71B between the substrate 1B and the insulation component 75B is different from the first signal wires 71B on the insulation component and the width of the non-touch region 13B is reduced to the width of the first signal wires 71B. Similarly, the first signal wires 71B in the upper layer location 79B and the lower layer location 77B can be the same. In addition, in other embodiments, the width of the signal wire is directly proportional to the length, that is, the longer signal wire leads to a larger width to balance the reduction of the touch signal of the signal wire in different lengths.

The touch panel of the present disclosure further includes a protection structure for covering and protecting the wire structure. In addition to covering the wire structure, the protection structure is further for covering the substrate or other components which needs protection. The embodiment is for illustrating but not for limiting the present disclosure.

Among the previous embodiments, one effect of the slim border is that the absolute value of the difference between the number of signal wire between the substrate and the insulation component and the number of the signal wires on the insulation component, wherein the signal wires between the substrate and the insulation component stand for the signal wires in the lower layer location and the signal wires on the insulation component stand for the signal wires in the upper layer location. The embodiment is for illustrating but not for limiting the present disclosure.

In the present disclosure, the wire structure around the sensing electrode structure is disposed on the upper and lower layer to reduce the width of the wire structure, so that the area of the non-touch region is reduced and the design of slim border is achieved. The designer applies the double layer wire structure of the present disclosure or combines the double layer wire structure of the present disclosure with the prior art to fulfill the purpose of reducing the width of the non-touch region.

The foregoing description has been presented for purposes of illustration. It is not exhaustive and does not limit the disclosure to the precise forms or embodiments disclosed. Modifications and adaptations will be apparent to those skilled in the art from consideration of the specification and practice of the disclosed embodiments of the disclosure. It is intended, therefore, that the specification and examples be considered as exemplary only, with a true scope and spirit of the disclosure being indicated by the following claims and their full scope of equivalents.

What is claimed is:

1. A touch panel, comprising:
a substrate, wherein a touch region and a non-touch region corresponding to the touch panel are both defined on the substrate;
a sensing electrode structure on the substrate and defining the touch region, the sensing electrode structure comprising a plurality of first sensing arrays and a plurality of second sensing arrays, wherein the plurality of first sensing array and the plurality of second sensing arrays are insulated to each other and are arranged interlacedly;
a first connecting component on an end of the plurality of second sensing arrays on the substrate and inside the non-touch region; and
a wire structure on the substrate and inside the non-touch region, comprising:
a plurality of first signal wires electrically connected to the plurality of first sensing arrays and the first connecting component respectively;
a plurality of second signal wires between the sensing electrode structure and the first connecting component, and electrically connected to one end of the plurality of second sensing arrays and the first connecting component respectively; and
an insulation component, wherein part of the plurality of first signal wires on the same side of the plurality second sensing arrays are between the substrate and the insulation component, and the other part of the plurality of first signal wires are on the insulation component.

2. The touch panel of claim 1, wherein each of the plurality of first sensing arrays is connected to one of the plurality of first signal wires.

3. The touch panel of claim 2, wherein the wire structure further comprises a plurality of third signal wires connected to the other end of the plurality of second sensing arrays and the first connecting component, and part of the plurality of first signal wires on the same side of the plurality second sensing arrays and part of the plurality of third signal wires on the same side of the plurality second sensing arrays are between the substrate and the insulation component, and the other part of the plurality of first signal wires and the other part of the plurality of third signal wires are on the insulation component correspondingly.

4. The touch panel of claim 1, wherein the two ends of each of the plurality of first sensing arrays are connected to a first wire and a second wire respectively, and the first wire and the second wire are two of the plurality of first signal wires.

5. The touch panel of claim 4, wherein the wire structure further comprises a plurality of third signal wire connected to the other end of the plurality of second sensing arrays and the first connecting component, and part of the plurality of first signal wires on the same side of the plurality second sensing arrays and part of the plurality of third signal wires on the same side of the plurality second sensing arrays are between the substrate and the insulation component, and the other part of the plurality of first signal wires and the other part of the plurality of third signal wires are on the insulation component.

6. The touch panel of claim 4, wherein the material of the first wire is different from the material of the second wire.

7. The touch panel of claim 1, wherein the touch panel further comprises a second connecting component on the substrate and inside the non-touch region of the other end of the second sensing array.

8. The touch panel of claim 7, wherein the wire structure further comprises a plurality of fourth signal wires and the plurality of fourth signal wires are between the sensing electrode structure and the second connecting component and are electrically connected to the plurality of second sensing arrays and the second connecting component.

9. The touch panel of claim 8, wherein part of the plurality of first signal wires are connected to the first connecting component, and the other part of the plurality of first signal wires are connected to the second connecting component.

10. The touch panel of claim 1, wherein an orthographic projection of the plurality of first signal wires between the substrate and the insulation component projected on the substrate overlaps an orthographic projection of the plurality of first signal wires on the insulation component projected on the substrate.

11. The touch panel of claim 1, wherein an orthographic projection of the plurality of first signal wires between the substrate and the insulation component projected on the substrate does not overlap an orthographic projection of the plurality of first signal wires on the insulation component projected on the substrate.

12. The touch panel of claim 1, wherein an orthographic projection of the plurality of first signal wires between the substrate and the insulation component projected on the substrate partially overlaps an orthographic projection of the plurality of first signal wires on the insulation component projected on the substrate.

13. The touch panel of claim 1, wherein a width of each of the plurality of first signal wires between the substrate and the insulation component is the same as a width of each of the plurality of first signal wires on the insulation component.

14. The touch panel of claim 1, wherein the widths of the plurality of first signal wires between the substrate and the insulation component are different from the widths of the plurality of first signal wires on the insulation component.

15. The touch panel of claim 1, wherein the widths of the plurality of first signal wires and the plurality of second signal wires are directly proportional to the length.

16. The touch panel of claim 1, wherein the difference between a number of the plurality of first signal wires between the substrate and the insulation component and a number of the plurality of first signal wires on the insulation component is not greater than 1.

17. The touch panel of claim 1, wherein the insulation component comprises a first insulation layer, a second insulation layer, and a shield layer, and the first insulation layer is on the substrate, and the shield layer is between the first insulation layer and the second insulation layer, and the second insulation layer is on the shield layer.

18. The touch panel of claim 1, further comprising a protection structure at least covering the wire structure.

19. The touch panel of claim 1, wherein part of the plurality of first signal wires on the insulation component pass through a hole on the insulation component and electrically connected to the plurality of first sensing arrays, and the hole is filled with a conductive material.

20. The touch panel of claim 1, wherein part of the plurality of first signal wires on the insulation component pass through a hole on the insulation component and electrically connected to the first connecting component, and the hole is filled with a conductive material.
